(19) United States
(12) Patent Application Publication
(10) Pub. No.: US 2026/0077668 A1
(43) Pub. Date: Mar. 19, 2026

(54) VEHICLE TO VEHICLE CHARGE TRANSFER

(71) Applicant: Volvo Car Corporation, Goteborg (SE)

(72) Inventors: Victor GUSTAFSON, Göteborg (SE); Henrik KLARS, Göteborg (SE); Michael ZACH, Göteborg (SE); Magnus AXELSSON, Göteborg (SE)

(73) Assignee: Volvo Car Corporation, Göteborg (SE)

(21) Appl. No.: 18/888,188

(22) Filed: Sep. 18, 2024

(51) Int. Cl. B60L 53/57; B60L 53/16; B60L 53/18; B60L 53/22; B60L 53/53; B60L 53/62; B60L 53/66; B60L 58/12; H02J 7/34

(52) U.S. Cl. CPC B60L 53/57; B60L 53/16; B60L 53/18; B60L 53/22; B60L 53/53; B60L 53/62; B60L 53/66; B60L 58/12; H02J 7/342; H02J 2207/20

(57) ABSTRACT

A device is described. The device comprises: a charging cable; a power conversion circuit; and a processor. The processor storing instructions in non-transitory memory that, when executed, causes the processor to: determine that a donor is connected to a recipient through the charging cable; determine an amount of first charge that a first battery pack of the donor can discharge; establish a bi-directional communication link with the recipient and obtain second charging configuration parameters of a second battery pack of the recipient; determine a charging specification to charge the second battery pack of the recipient based on the second charging configuration parameters; communicate a command to the power conversion circuit to convert a first power from the donor to a second power based on the charging specification; and transfer the second power through the charging cable as per the charging specification to charge the second battery pack of the recipient.

### FIELD OF THE INVENTION

The present disclosure relates generally to a charging connector. More specifically, the present disclosure relates to a vehicle-to-vehicle charging connector that transfers charge adaptable to charging requirements of recipient to jumpstart or to charge the drained battery of the vehicle.

### BACKGROUND

“Nobody wants to get into their car, attempt to turn the engine on, and find that their vehicle's battery is dead. Not only is a dead car battery frustrating and inconvenient, but it can also be expensive to fix if there is a major issue with one of the battery components. Whether you accidentally left your lights on overnight, have an old car with a worn-out battery, or your car's battery has experienced an unexpected and unexplainable fault, there are many reasons why your car might refuse to start.” “As a result, you might end up needing to use jump leads to jump-start your vehicle in order to drive it.” [Source: Publication titled “4 Reasons Why You Might Need to Jump Start Your Vehicle”; by Staff; published 17^{th} April 2023]

Further “[E]lectric vehicles are charged by charging stations. However, because the number of the charging stations is limited, it is inconvenient to charge the electric vehicle, thus affecting popularity of the electric vehicle. In addition, due to the effect of the road condition or the users' habits, the driving distance calculated by the battery manager may have certain error. Thus, it is possible that before reaching the destination, the remaining power in the battery is insufficient or even has been exhausted, which may leave the user in trouble.” [Source: United States Patent Application number U.S. Pat. No. 10,059,210B2; titled “Vehicle mutual-charging system and charging connector”; published 22^{nd} December 2016]

Therefore, there is a long-felt need for a vehicle-to-vehicle charging connector to jumpstart or to charge the vehicle.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, methods, and/or apparatus are presented that describes a vehicle-to-vehicle charging connector for transferring charge adaptable to charging requirements of recipient.

In an aspect, a device is described. The device comprises: a charging cable; a power conversion circuit; and a processor. The processor storing instructions in non-transitory memory that, when executed, causes the processor to: determine that a donor is connected to a recipient through the charging cable; determine an amount of first charge that a first battery pack of the donor is capable of discharging; establish a bi-directional communication link with the recipient and obtain one or more second charging configuration parameters of a second battery pack of the recipient; determine a charging specification to charge the second battery pack of the recipient based on the one or more second charging configuration parameters; communicate a command to the power conversion circuit to convert a first power from the donor to a second power based on the charging specification; and transfer the second power through the charging cable as per the charging specification to charge the second battery pack of the recipient.

In an aspect, a method is described. The method comprises: determining, by a processor of a connector, that a donor is connected to a recipient through a charging cable; determining an amount of first charge that a first battery pack of the donor is capable of discharging; establishing a bi-directional communication link with the recipient and obtaining one or more second charging configuration parameters of a second battery pack of the recipient; determining a charging specification to charge the second battery pack of the recipient based on the one or more second charging configuration parameters; communicating a command to a power conversion circuit to convert a first power from the donor to a second power based on the charging specification; and transferring the second power through the charging cable as per the charging specification to charge the second battery pack of the recipient.

In an aspect, a non-transitory computer readable storage medium is described. A non-transitory computer readable storage medium comprising a sequence of instructions which when executed by a processor causes: determining that a donor is connected to a recipient through a charging cable; determining an amount of first charge that a first battery pack of the donor is capable of discharging; establishing a bi-directional communication link with the recipient and obtaining one or more second charging configuration parameters of a second battery pack of the recipient; determining a charging specification to charge the second battery pack of the recipient based on the one or more second charging configuration parameters; communicating a command to a power conversion circuit to convert a first power from the donor to a second power based on the charging specification; and transferring the second power through the charging cable as per the charging specification to charge the second battery pack of the recipient.

In an aspect, a system is described. The system comprises: a connector, a processor, and a 12-voltage conversion circuit. The connector is connected to a donor and a recipient. The processor is configured to determine that a 24-volt battery of a donor is connected to a 12-volt battery of a recipient based on information received from the connector; determine an amount of charge that the donor is capable of discharging based on an anticipated routing and a required charge for the anticipated routing; and communicate a command to a 12-voltage connection circuit to initiate discharge of 12 volts to the recipient. The 12-voltage conversion circuit is configured to convert the 24 volts received from the donor to the 12 volts and initiate the discharge and provide the 12 volts to the 12-volt battery of the recipient.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a device, according to one or more embodiments.

FIG. 2 illustrates a method, according to one or more embodiments.

FIG. 3 illustrates a non-transitory computer readable storage medium, according to one or more embodiments.

FIG. 4 illustrates a schematic diagram illustrating a technical idea of a vehicle-to-vehicle charge transfer at a high level, according to one or more embodiments.

FIG. 5 illustrates a reverse current protection circuit, according to one or more embodiments.

FIG. 6 illustrates a battery pack comprising an individual battery, according to one or more embodiments.

FIG. 7 illustrates a battery pack comprising a plurality of batteries, according to one or more embodiments.

FIG. 8 schematically shows a battery pack and a battery management system, according to one or more embodiments.

FIG. 9 illustrates a command sent by a processor to a power conversion unit, according to one or more embodiments.

FIG. 10 illustrates a DC-to-DC converter, according to one or more embodiments.

FIGS. 11, 11A, 11B and 11C illustrate a DC-to-DC converter, according to one or more embodiments.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

Embodiments may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

The following terms and phrases, unless otherwise indicated, shall have the following meanings.

As used herein, the term “electric vehicle (EV)” refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein the term “plug” refers to a component attached to an electrically-operated device, often via a cable.

As used herein, the term “heavy duty vehicle (HD Vehicle)” refers to any four- or more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4, 545 kg gross vehicle weight.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service, and of the emergency-reporting vehicle.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as AMQP, MQTT, Zigbee, etc.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation etc. In an embodiment, sensors may be removably or fixedly installed within the vehicle and may be disposed in various arrangements to provide information to the autonomous operation features. The sensors may include electronic battery sensors, voltage sensors, etc. Some of the sensors may actively or passively determine voltage across the plugs connected to the respective batteries of the respective vehicles to determine whether there is connection established between those vehicles etc.

The term “vehicle” as used herein refers to a thing used for transporting people or goods. Automobiles, cars, trucks, buses, etc., are examples of vehicles.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

As used herein, the term “connector” refers to an interface between a donor and a recipient. The connector consists of specific pins or contacts or plugs that allow for the safe and efficient transfer of electricity and often includes communication capabilities to ensure proper and safe charging.

As used herein, the term “charging cable” refers to a power transfer cable that allows vehicles to transfer power between each other. This can be particularly useful in situations where one vehicle needs a boost, and another vehicle has surplus charge. The charging cable is a cable for transferring electrical energy from a donor to a recipient's battery, allowing it to recharge. As used herein, the term “donor” refers to a vehicle that has abundant charge. The donor may be one of an electric vehicle (EV), and a plug-in hybrid electric vehicle (PHEV). The donor may be one of an autonomous vehicle, semi-autonomous vehicle, manual driven vehicle. The donor may operate in autonomous mode.

As used herein the term “abundant charge” refers to a close to maximum capacity of charge of a battery.

As used herein, the term “recipient” refers to a vehicle that has negligible charge. The recipient may be one of an electric vehicle (EV), a hybrid electric vehicle (HEV), an internal combustion engine vehicle (ICEV), and a plug-in hybrid electric vehicle (PHEV). The recipient is a vehicle that has a drained battery and does not have any charge available to start/operate the vehicle. The recipient may be one of an autonomous vehicle, semi-autonomous vehicle, manual driven vehicle. The recipient may operate in autonomous mode.

As used herein the term “negligible charge” refers to a very small or insignificant amount of electric charge.

As used herein, the term “discharge” refers to the release or flow of stored electrical energy from a power source, such as a battery pack or capacitor, to an external circuit or load (e.g., another vehicle, a charging station). The term discharge refers to a process where a battery releases its stored chemical energy, as electrical energy, to power or charge a device (e.g., battery of a vehicle).

As used herein, the term “bi-directional communication” refers to a communication link that allows data transmission in both directions between two vehicles. This type of link enables interactive communication, where each vehicle can both send and receive information. The term “bi-directional communication” as used herein refers to an exchange of data between two vehicles. In an example, the first component can be a donor vehicle and the second component can be a recipient vehicle that is enabled by a system of hardware, software, and firmware.

As used herein, the term “vehicle to vehicle (V2V) communication” refers to the technology that allows vehicles to broadcast and receive messages. The messages may be charging request messages or discharging request messages, creating a 360-degree “awareness” of charging status of the vehicles in proximity. Vehicles may be equipped with appropriate software (or safety applications) that can use the messages from surrounding vehicles to transfer charge between the vehicles.

As used herein, the term “charging configuration parameters” refers to various settings and specifications that determine how a device, typically a battery of an electric vehicle (EV) or battery-powered system, is charged. These parameters ensure that the charging process is safe, efficient, and compatible with the device's requirements. The key charging configuration parameters include voltage, current, power, temperature, Charging Rate (C-rate), State-of-Charge (SOC), etc.

As used herein, the term “charging specification” refers to the detailed requirements and characteristics that define how a device, typically an electric vehicle (EV) or a battery-powered system, should be charged. These specifications encompass various aspects such as voltage, current, power levels, connector types, and communication protocols. Further, the charging specification refers to a maximum amount of electrical energy that a battery pack or an electrical device can accept and store during the charging process. This capacity is typically measured in units such as ampere-hours (Ah) or milliampere-hours (mAh) for batteries, and it indicates the efficiency and capability of the battery pack to store energy.

As used herein, the term “charge-discharge rate,” also referred to as the C-rate, defines how quickly the battery pack can be charged or discharged relative to its capacity. Charge-discharge rate is expressed as a multiple of the battery's rated capacity (C).

As used herein, the term “charging duration” refers to the amount of time required to charge a battery pack to a desired level from a depleted state to its desired capacity. In an embodiment, the desired capacity may be the capacity required to jumpstart the recipient. In an embodiment, the desired capacity may be the full capacity. The charging duration depends on several factors, including: battery capacity (C), charging current (I), and C-rate.

As used herein, the term “charging temperature” refers to the temperature range within which a battery can be safely and efficiently charged. This range is crucial for maintaining the battery's performance, safety, and lifespan. Charging a battery outside its recommended temperature range can lead to several issues, such as reduced efficiency, decreased capacity, and potential safety hazards like overheating or thermal runaway.

As used herein, the term “optimal charge percentage level to stop charging” refers to charge percentage level at which the desired capacity of the battery is achieved, and the charging process is stopped.

As used herein, the term “itinerary information” refers to a detailed schedule of activities and events planned for a trip or event. The itinerary information comprises travel details such as vehicle ID, departure and arrival locations, departure and arrival times, intermediary waiting location, waiting time (halt time), no. of occupants, estimated charge consumption, etc.

As used herein, the term “anticipated routing” refers to the planned or expected path that a vehicle or other moving entity will follow from its origin to its destination. The anticipated routing comprises travel details such as vehicle ID, departure and arrival locations, departure and arrival times, intermediary waiting location, waiting time (halt time), etc.

As used herein, the term “jumpstart” refers to starting the vehicle using an external power source, typically another vehicle with a functioning battery, to start a vehicle with a dead or discharged battery. The jumper cable or charging cable may be needed to jumpstart the vehicle.

As used herein, the term “electronic battery sensors” refers to devices used to monitor various parameters of a battery to ensure safe and efficient operation. The electronic battery sensors connected to a donor battery pack and recipient battery pack monitor various parameters (e.g., voltage, power, etc.) of the respective battery packs. The processor based on the signal determines that there is a connection between the donor battery pack and recipient battery pack.

As used herein, the term “Battery Management System (BMS)” refers to an electronic system designed to monitor and manage the performance, safety, and reliability of a rechargeable battery. The BMS ensures that the battery operates within its optimal parameters, thereby maximizing its lifespan and efficiency.

As used herein, the term “autonomous mode” refers to a vehicle operating mode which is independent and unsupervised.

As used herein, the term “autonomous communication” comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

As used herein, the term “communication protocol” refers to standardized communication between any two systems. An example of a communication protocol is the DSRC protocol. The DSRC protocol uses a specific frequency band (e.g., 5.9 GHZ) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

As used herein, the term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein, the term “semi-autonomous vehicle” refers to vehicles that can operate for extended periods with little human input. A semi-autonomous vehicle cannot drive itself at all times but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein, the term “battery pack” refers to a collection of individual battery cells or modules electrically connected to each other to achieve a desired voltage, capacity, and performance. The battery pack typically includes additional components such as a battery management system (BMS), connectors, and sometimes cooling systems. The primary purpose of a battery pack is to provide a reliable and compact energy storage solution suitable for specific applications.

As used herein, the term “power conversion circuit” refers to a device or circuit that converts electrical energy from one form to another. This conversion typically involves altering voltage, current, or frequency to suit specific requirements of electrical systems or devices (e.g., recipient vehicles). The conversion circuit may comprise one of a transformer, and a DC-to-DC converter. The power conversion circuit further refers to an electronic circuit designed to change electrical power from one form to another, such as from AC to DC, DC to AC, or between different voltage levels of DC. The power conversion circuit is configured to convert a first voltage of the output power from the donor to a second voltage adaptable to recharge a battery pack of the recipient. The power conversion circuit is also configured to convert the output power from the donor to a charging specification based on one or more charging parameters of the battery pack of the recipient.

As used herein, the term “transformer” refers to a device that transfers electrical energy between two or more circuits through electromagnetic induction. The primary function of a transformer is to change the voltage levels between circuits. This can either be stepping up (increasing) or stepping down (decreasing) the voltage. The transformer comprises a primary winding and a secondary winding. When an alternating current (AC) flows through the primary winding, it creates a varying magnetic field in the core. This varying magnetic field induces a voltage in the secondary winding, based on Faraday's law of electromagnetic induction. The transformer may be one of a step-up transformer, a step-down transformer, and an isolation transformer. The step-up transformer increases voltage from primary to secondary winding. The step-down transformer decreases voltage from primary to secondary winding. The isolation transformer provides electrical isolation without changing the voltage significantly.

As used herein, the term “DC-to-DC converter” refers to a device that converts a source of direct current (DC) from one voltage level to another. These converters are widely used in various applications where the power supply needs to be regulated and adaptable for recipient charging requirement. The primary function of a DC-to-DC converter is to efficiently change the DC voltage level to match the requirements of different parts of an electronic system, ensuring proper operation and power efficiency.

As used herein, the term “charging sequence” refers to a charging pattern defined by the connector based on the charging configuration parameters. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

As used herein, the term “circuit” refers to an arrangement of interconnected components that has at least one input and one output terminal, and whose purpose is to produce at the output terminals a signal that is a function of the signal at the input terminals.

As used herein, the term “battery management system (BMS)” refers to a system that is used to monitor and control power storage systems, assure health of battery cells, and deliver power to vehicle systems. Isolation products have numerous uses inside BMS in the electrical domains of Electric Vehicles (EV) or Hybrid Electric Vehicles (HEV).

As used herein, the term “degraded cells” refers to energy storage cells where the physical and chemical changes have occurred. The degraded cells can store, receive, or deliver energy less than the actual capacity.

As used herein, the term “healthy cells” refers to energy storage cells which can store, receive, or deliver energy equal to the actual capacity.

As used herein, the term “moderate degraded cells” refers to energy storage cells which can store, receive, or deliver energy less than the actual capacity but equal to a threshold capacity.

As used herein, the term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc. that are executed on separate control units. The vehicle computer system may be communicatively coupled with an external device of a user. The vehicle computer system may also be communicatively coupled with the other electric vehicle and connector.

As used herein, the term “level 1 charging” refers to a charge that uses 120-207 Volts. Level 1 charging may be the slowest way to charge a battery of the vehicle.

As used herein, the term “level 2 charging” refers to a charge that uses 208-240 Volts.

As used herein, the term “level 3 charging” refers to a charge that uses 400-900 Volts DC. Level 3 charging is the fastest type of charging available.

As used herein, the term “maximum charging” or “optimally charging” as used refers to a maximum rate at which the charging is provided to the battery pack during the charging duration without damaging the battery pack.

As used herein, the term “trickle charging” refers to charging a battery pack continuously or periodically with a very small current. The trickle charge also refers to a continuous, slow charge applied to the battery pack.

As used herein, the term “fast charging” refers to charging a battery pack faster than regular charging.

As used herein, the term “regular charging” refers to charging a battery pack by supplying a standard charging voltage employed according to the capacity of the battery pack.

As used herein, the term “state-of-charge (SoC)” refers to the level of charge of an electric battery relative to its capacity. The units of SoC are percentage points (0%=empty; 100%=full). An alternative form of the same measure is the depth of discharge (DoD), the inverse of SoC (100%=empty; 0%=full). SoC is normally used when discussing the current state of a battery in use, while DoD is most often seen when discussing the lifetime of the battery after repeated use.

As used herein, the term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. It is expressed in percentage form.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to one or more embodiments described herein. In this regard, each block in the flowchart or block diagrams can represent a module, segment, and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phonc), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be cither hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches, and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim. The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem: It is important to drive with a charged and functional battery at all times. That said, a battery is prone to damage, and several factors can cause problems, such as a car battery not charging. These issues can also be caused by external damage or by normal wear and tear. Further the most common problem that the vehicle encounters is that a vehicle battery is not charging. There can be several reasons and causes behind it. In such above cases, it is possible that before reaching the destination, the remaining power in the battery may get drained and is insufficient or even has been exhausted to start the vehicle, which may leave the user in trouble.

The stranded vehicle may have to hire a towing service or a mechanic to rescue the vehicle. In some cases, the vehicle may be stranded in jungles or non-accessible areas where the rescue operation is not available. In such a situation, there remains a need for a portable, compact, and cost-effective connector that can be added as an additional tool to the existing vehicles.

Business Solution: The present disclosure provides a cost-effective connector that can be added to the existing donor vehicle to provide charge to the recipient which is stranded. The cost-effective connector may be Vehicle-to-vehicle charge transfer connector. The connector comprises the power conversion circuit that provides charge adaptable to charging requirements of the recipient. The recipient comprises, for example, a 2V battery pack, a 6V battery pack, etc. The connector is portable, not heavy, and is compact to be carried within the vehicle to the spot whether the recipient is stranded with a drained battery or a dead battery. The connector can be added as an additional tool to the existing vehicle and donate charge to the recipient which in turn provides monetary benefits to the donor. This monetary benefit creates a business gap. A “business gap” typically refers to a discrepancy or a missing element within a business that represents an opportunity for improvement, growth, or innovation. Identifying and addressing business gaps is crucial for maintaining competitiveness and achieving strategic objectives. The proposed solution identifies and addresses the business gap.

Technical problem: A battery pack is an integral component of the vehicle. The battery pack helps with starting and powering some major components such as lights, horns, and stereo, among others. Although modern vehicle batteries are far better than their predecessors, they still come with a running life. Other than the normal wear and tear, car batteries can also encounter some problems contributing to an affected driving experience.

While electric cars rely on a battery to start, petrol vehicles cannot run without a battery as well. However, it is advised to avoid starting or driving a vehicle with a battery that exceeds its warranty or lifespan, as some major safety indicators like car battery warning light among others may not function at all. Therefore, it is important to drive with a charged and functional battery at all times. That said, a battery is prone to damage and several factors can cause problems such as a car battery not charging. These issues can also be caused by external damage or by normal wear and tear.

One of the common problems is a vehicle battery not charging. There can be several reasons and causes behind it. Loose Wiring: When driving over rough terrains or uneven surfaces, the car experiences abrupt jolts and bounce. This can at times lead to loosened wiring. Usually, this is an issue in older vehicles. If any of the wires are loose, the electrical connection between the alternator and battery may become weak-leading to a car battery not charging. Bad Alternator: An alternator charges the car battery when the vehicle is in motion. A faulty alternator may affect the battery's charging. A vehicle alternator usually has a long lifespan however, it can encounter premature damage. Battery Age: If a car battery is past its running life, it may also cause charging problems. A vehicle battery has a long-running life, but bad driving habits and excess usage may contribute to premature deterioration-leading to problems like a vehicle battery not charging. Damaged alternator belt: In some cases of a conventional vehicle battery charging, the problem may lie in the alternator belt also known as the serpentine belt. The alternator belt converts mechanical energy from the engine back into electrical charge for vehicle systems and the battery. At times, the belt may become frayed or loose-failing to keep up with the power needs of the vehicle.

Bad Power Conversion circuit: In some cases of a vehicle battery charging, the problem may lic in the power conversion circuit or rectifier that feeds the required voltage to the vehicle's battery. To charge a battery pack, the charging voltage needs to be higher than the battery terminal voltage. The power conversion circuit is responsible for supplying the charging voltage higher than the battery terminal voltage.

In such above cases, it is possible that before reaching the destination, the remaining power in the battery may get drained and is insufficient or even has been exhausted to start the vehicle, which may leave the user in trouble.

Technical Solution: Proposed is a system that would allow a donor (e.g., battery electric vehicle (BEV)) to provide a charge, via a charging connector and a charging cable, to a battery pack (e.g., drained battery (e.g., 12 Volt Battery, 6-volt battery, etc.) of any entity (e.g., Internal Combustion Engine Vehicle (ICEV), EV, PEV, PHEV, a device, etc.) at least sufficient to jumpstart the entity. For example, when a 12V battery requires a recharge, a BEV requires to discharge more energy than it would if providing charge to another EV or BEV car.

In an aspect, a connector is provided that is connected to the BEV charging outlet to a processor. The connector has a 12V connection circuit (e.g., power conversion circuit) and standard connector. The standard connector is used to receive and discharge the energy from the donor (e.g., BEV). The connector also allows for tracking the amount of energy discharged (e.g., for revenue collection) from the donor. The 12V connection is used to provide a charge to a dead 12V battery. The processor determines that the battery pack of the donor is connected to a dead 12V battery of the recipient based on information provided by the connector. In such a case, the processor initiates discharge sequence for a 12V battery of the recipient. This includes whether or not there is enough charge to discharge for a 12V battery based on anticipated routing and required battery charge for the planned trip. Once the processor determines the amount of charge the system can discharge, the discharge is initiated until an indication is received that discharge is no longer required. This indication may be received via the connector or a signal from an external device. In an aspect, once the recipient (e.g., 12V vehicle) is powered and is self-charging, the recipient can send a signal to the donor that is providing the charge to stop discharging.

Technical Result: The present disclosure discloses the connector that connects the donor and the recipient via the charging cable and enables charge transfer power from the donor to the recipient. The connector is further configured to provide power adaptable to charging configuration parameters of the recipient. The connector is capable of converting the discharge power from the first voltage to the second voltage adapted to charge the battery pack of the recipient safely and securely. The connector is also capable of charging the recipient up to desired level (for example, charging level required to start the recipient). In an embodiment, the connector also stops discharging from the donor and stops transferring power to the recipient upon receiving an indication.

How Technical Solution is a Technological Advancement: The connector enables the recipient to get charged from the donor at the stranded place. The connector requires very less manual intervention in transferring charge. The connector further transfers charge from the donor to the recipient up to the desired level. The connector further automatically stops the discharge from the donor upon receiving an indication or upon reaching the desired charge level. The connector is capable of tracking the power discharge from the donor to the recipient and is capable of calculating and getting monetary benefits against the power transferred. The connector further provides the technological advancement of receiving the discharge from the donor and converting it to the power adaptable to charge the recipient as per the charging specification of the recipient. Technical Details Specific to the Technical Solution:

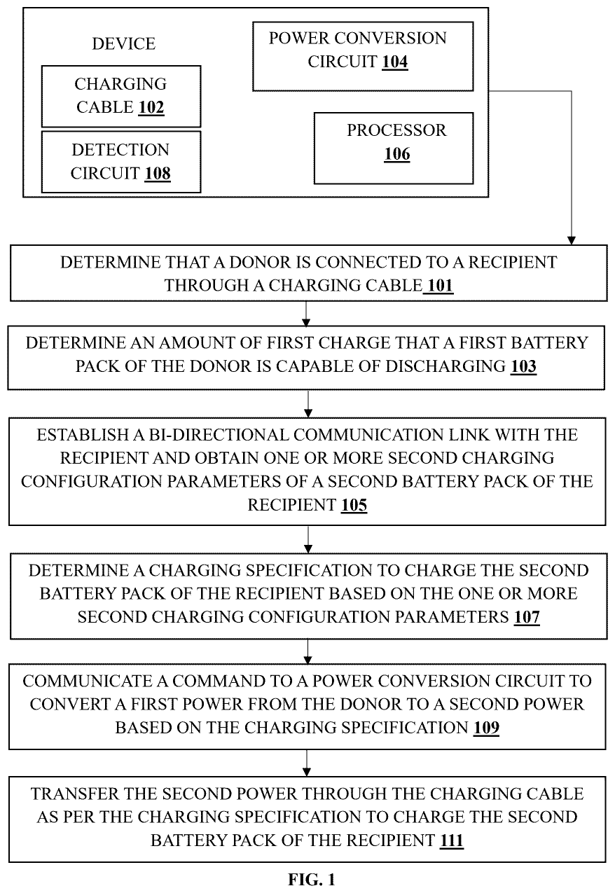

In an aspect, a device is described. As an example, FIG. 1 illustrates a device, according to one or more embodiments. In an embodiment, the device is a connector that enables vehicle-to-vehicle charge transfer. The device disclosed herein comprises: a charging cable 102; a power conversion circuit 104; and a processor 106. The processor 106 storing instructions in non-transitory memory that, when executed, causes the processor to: determine that a donor is connected to a recipient through the charging cable (at step 101); determine an amount of first charge that a first battery pack of the donor is capable of discharging (at step 103); establish a bi-directional communication link with the recipient and obtain one or more second charging configuration parameters of a second battery pack of the recipient (at step 105); determine a charging specification to charge the second battery pack of the recipient based on the one or more second charging configuration parameters (at step 107); communicate a command to the power conversion circuit to convert a first power from the donor to a second power based on the charging specification (at step 109); and transfer the second power through the charging cable as per the charging specification to charge the second battery pack of the recipient (at step 111). In an embodiment, the first power comprises a first voltage and the second power comprises a second voltage. The first voltage is the voltage between the terminals of the first battery pack and the second voltage is the voltage between the terminals of the second battery pack.

The one or more second charging configuration parameters comprises at least one of a rated charging capacity, a charge-discharge rate, a state-of-charge (SoC), a state-of-health (SoH), a charging duration, a nominal voltage, and a maximum charging voltage. The charging specification comprises at least one of a charging voltage, a charging current, a charging power, a charging duration, a charging temperature, a charging sequence, and an optimal charge percentage level to stop charging. The charging voltage referred to above may be the second voltage adapted to charge the second battery pack of the recipient.

The donor is a first vehicle that comprises abundant charge and the recipient is a second vehicle that comprises negligible charge. In an embodiment, the donor comprises one of an electric vehicle (EV), a hybrid electric vehicle (HEV), an internal combustion engine vehicle (ICEV), and a plug-in hybrid electric vehicle (PHEV). The recipient comprises one of an electric vehicle (EV), a hybrid electric vehicle (HEV), an internal combustion engine vehicle (ICEV), and a plug-in hybrid electric vehicle (PHEV).

In an embodiment, the device further comprises a detection circuit 108. The processor 106 is operable to determine that the donor is connected to the recipient via the charging cable 102 using the detection circuit. The charging cable 102 comprises a first plug and a second plug. The first plug is adapted to connect the charging cable 102 to a charging outlet of the donor. The second plug is adapted to connect the charging cable 102 to the second battery pack of the recipient. In an embodiment, the detection circuit 108 comprises one or more electronic battery sensors that determines one or more first charging configuration parameters of the first battery pack of the donor and the one or more second charging configuration parameters of the second battery pack of the recipient. The one or more electronic battery sensors may be electrically coupled to the first battery pack of the donor through the first plug. The one or more electronic battery sensors may be electrically coupled to the second battery pack of the recipient through the second plug.

The processor 106 determines a first potential between the terminals of the first battery pack via the first plug and a second potential between the terminals of the second battery pack via the second plug. In an embodiment, the processor 106 determines a first potential via the first plug and a second potential based on the one or more first charging configuration parameters of the first battery pack of the donor and the one or more second charging configuration parameters of the second battery pack of the recipient, respectively. The processor 106 then determines that the donor is connected to the recipient based on comparing the first potential at the first plug and the second potential at the second plug. The processor 106 determines the first charging configuration parameters of the donor and the second charging configuration parameters of the recipient based on the difference between the first potential at the first plug and the second potential at the second plug. For example, consider the first potential between the terminals of the first battery pack is 12 volt and the second potential between the terminals of the second battery pack is 6 volt. The processor 106 based on the difference between the first potential at the first plug and the second potential at the second plug determines that the donor is a vehicle (e.g., four-wheeler) and the recipient is other vehicle (e.g., motorcycle, electric cycle, car, etc.).

In another embodiment, the device may also comprise a sensor (e.g., camera) configured to capture images/videos of the donor and the recipient. The sensor communicates a signal to the processor. The processor 106 upon performing image analysis determines the vehicle type of the donor and the vehicle type of the recipient. In another embodiment, processor 106 upon performing image analysis determines the entity type of the donor and the entity type of the recipient. In one embodiment, the device comprises a reverse current protection circuit as explained below.

The processor 106 is operable to communicate with one of a first vehicle computer system of the donor and an external system to extract itinerary information of the donor. The itinerary information of the donor comprises at least one of a departure point, a departure time, an intermediate point, a waiting duration, an arrival time, and a destination point. The processor 106 is operable to receive a state-of-charge of the first battery pack of the donor from one of a battery management system and the first vehicle computer system of the donor. The processor 106 is also operable to determine an anticipated routing and determine the amount of second charge required to execute and complete the anticipated routing based on the itinerary information of the donor. The processor 106 is further operable to determine the amount of first charge, that the first battery pack of the donor is capable of discharging, from the state-of-charge of the first battery pack and the amount of second charge required to execute and complete the anticipated routing.

The processor 106 converts the first power to the second power and transfers the second power till it reaches the amount of first charge to the second battery pack of the recipient. In an embodiment, the processor 106 is operable to transfer the second power through the charging cable 102 to the second battery pack of the recipient to jumpstart the recipient. In another embodiment, the processor 106 is operable to transfer the second power through the charging cable 102 to the second battery pack of the recipient to charge the recipient to a predefined charging level. In another embodiment, the processor 106 is operable to transfer the second power through the charging cable till an indication is received by the processor. The processor 106 is operable to receive the indication from at least one of an external device and a second vehicle computer system of the recipient upon charging the second battery pack to an optimal charge percentage level. In an embodiment, the optimal charge percentage level is a minimum charge level capable of jumpstarting the recipient. The device keeps track of the amount of the first charge, the state-of-charge, and the amount of second charge transferred from the donor to the recipient.

The processor 106 is operable to transmit the tracked information (such as the amount of the first charge, the state-of-charge, and the amount of second charge) to the first vehicle computer system of the donor and the second vehicle computer system of the recipient to display it on the respective dashboard displays to keep the users informed. The processor 106 is operable to transmit the tracked information (such as the amount of the first charge, the state-of-charge, and the amount of second charge) to the external devices of the users (e.g., personal digital assistants, smartphones, laptop, smart watch, etc.) to keep the users informed. The users may communicate an indication to the processor 106 upon desired level of power transferred between the donor and the recipient. The processor 106, upon receiving the indication, may then stop discharging.

In an embodiment, the device transfers the second power from the donor to the recipient as per the charging specification. In one embodiment, the device transfers the second power from the donor to the recipient as per the state-of-health of the second battery pack. In another embodiment, the device transfers the second power from the donor to the recipient as per the state-of-charge of the second battery pack. In another embodiment, the device transfers the second power from the donor to the recipient as per the rated charging capacity of the second battery pack. In another embodiment, the device transfers the second power from the donor to the recipient as per the charge-discharge rate of the second battery pack. In another embodiment, the device transfers the second power from the donor to the recipient as per the nominal voltage, and the maximum charging voltage of the second battery pack. In another embodiment, the device may transfer the second power as per a charging temperature. In another embodiment, the device may transfer the second power as per the optimal charge percentage level to stop charging. In another embodiment, the device may transfer the second power as per a charging sequence. The charging sequence refers to a charging pattern defined by the device (i.e., connector) based on the charging configuration parameters. The charging sequence may define a charging level for a predefined charging time segment. According to this embodiment, the device transfers the second power at a charging level from the donor to the recipient for a predefined charging time segment. The charging level may comprise a regular charging, a fast charging, optimal charging, and a trickle charging. The optimal charging refers to a maximum rate at which the charging is provided to the second battery pack during the charging duration without damaging the second battery pack. The trickle charging refers to charging the second battery pack continuously or periodically with a very small current. The trickle charge also refers to a continuous, slow charge applied to the battery pack. The regular charging refers to charging the second battery pack of the recipient by supplying a standard charging voltage employed according to the capacity (charging specification) of the second battery pack.

The charging level may also comprise a level 1 charging, a level 2 charging, and a level 3 charging. The level 1 charging refers to a charge that uses 120-207 Volts. Level 1 charging may be the slowest way to charge the second battery pack of the recipient. The level 2 charging refers to a charge that uses 208-240 Volts to charge the second battery pack of the recipient. The level 3 charging refers to a charge that uses 400-900 Volts DC to charge the second battery pack of the recipient. Level 3 charging is the fastest type of charging available.

The charging sequence may also define a charging level for a predefined portion (e.g., healthy cells, degraded cells) of the battery pack. According to this embodiment, the device transfers the second power at a charging level from the donor to the recipient for the predefined portion of the second battery pack of the recipient. The predefined portion refers to a portion of the second battery pack comprising at least one of healthy cells, moderate degraded cells, and degraded cells. The healthy cells refer to energy storage cells which can store, receive, or deliver energy equal to the actual capacity. The moderate degraded cells refer to energy storage cells which can store, receive, or deliver energy less than the actual capacity but equal to a threshold capacity. The degraded cells refer to energy storage cells where the physical and chemical changes have occurred. The degraded cells can store, receive, or deliver energy less than the actual capacity.

In an embodiment, the power conversion circuit may comprise a DC-to-DC converter. The DC-to-DC converter may be one of a step-down/buck converter, a step-up/boost converter, and a buck-boost converter. A DC-DC converter is an electronic circuit that facilitates the conversion of direct current from one voltage level to another based on the requirements. The DC-DC converter circuits employ high-frequency power conversion using switches and other passive components to eliminate the switching noise, thus regulating the output voltage.

Buck Converter (Step-Down Converter): Buck Converter steps down the input voltage to a lower output voltage while increasing the output current. The buck converter employs a series of switches, an inductor, and a capacitor to regulate the output voltage by adjusting the duty cycle of the switches. Buck converters are commonly used in applications that require a lower voltage level than the input supply, such as battery-powered vehicles.

Boost Converter (Step-Up Converter): Boost Converter steps up the input voltage to a higher output voltage while decreasing the output current. Boost Converter utilizes switches, an inductor, and a capacitor to manage energy transfer, resulting in an increased output voltage. Boost converters are commonly used in applications requiring a higher output voltage than the input supply.

Buck-Boost Converter: Buck-Boost Converter is a versatile topology that can step up or step down the input voltage, depending on the duty cycle of the switches. Buck-Boost Converter topology combines elements of both buck and boost converters, making it suitable for applications with varying input voltages or when both step-up and step-down conversions are needed. Buck-boost converters are used in applications such as battery-powered devices with fluctuating voltage levels.

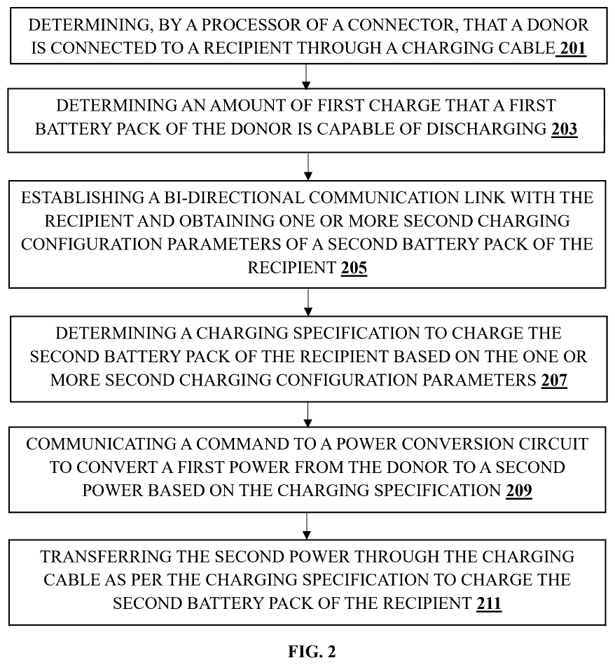

In an aspect, a method is described. As an example, FIG. 2 illustrates a method, according to one or more embodiments. The method comprises: determining, by a processor of a connector, that a donor is connected to a recipient through a charging cable (at step 201); determining an amount of first charge that a first battery pack of the donor is capable of discharging (at step 203); establishing a bi-directional communication link with the recipient and obtaining one or more second charging configuration parameters of a second battery pack of the recipient (at step 205); determining a charging specification to charge the second battery pack of the recipient based on the one or more second charging configuration parameters (at step 207); communicating a command to a power conversion circuit to convert a first power from the donor to a second power based on the charging specification (at step 209); and transferring the second power through the charging cable as per the charging specification to charge the second battery pack of the recipient (at step 211). In an embodiment, the one or more second charging configuration parameters comprises at least one of a rated charging capacity, a charge-discharge rate, a state-of-charge (SoC), a state-of-health (SoH), a charging duration, a nominal voltage, and a maximum charging voltage. In an embodiment, the charging specification comprises at least one of a charging voltage, a charging current, a charging power, a charging duration, a charging temperature, a charging sequence, and an optimal charge percentage level to stop charging. In an embodiment, the first power comprises a first voltage and the second power comprises a second voltage.

In an embodiment, the donor is a first vehicle that comprises abundant charge and the recipient is a second vehicle that comprises negligible charge. The donor comprises one of an electric vehicle (EV), a hybrid electric vehicle (HEV), an internal combustion engine vehicle (ICEV), and a plug-in hybrid electric vehicle (PHEV). The recipient comprises one of an electric vehicle (EV), a hybrid electric vehicle (HEV), an internal combustion engine vehicle (ICEV), and a plug-in hybrid electric vehicle (PHEV).

In an embodiment, the method further comprises: communicating with one of a first vehicle computer system of the donor and an external database to extract itinerary information of the donor. The itinerary information of the donor comprises at least one of a departure point, a departure time, an intermediate point, a waiting duration, an arrival time, and a destination point. The method further comprises: receiving a state-of-charge of the first battery pack of the donor from one of a battery management system and the first vehicle computer system of the donor; determining an anticipated routing and determining an amount of second charge required to execute and complete the anticipated routing based on the itinerary information of the donor; and determining the amount of first charge, that the first battery pack of the donor is capable of discharging, from the state-of-charge of the first battery pack and the amount of second charge required to execute and complete the anticipated routing.

The method further comprises: transferring the second power through the charging cable to the second battery pack of the recipient to jumpstart the recipient. In an embodiment, the method further comprises: transferring the second power through the charging cable to the second battery pack of the recipient to charge the recipient. In one embodiment, the method further comprises: transferring the second power through the charging cable till an indication is received by a processor. In one embodiment, the method further comprises: receiving the indication from at least one of an external device and a second vehicle computer system of the recipient upon charging the second battery pack to an optimal charge percentage level. The optimal charge percentage level is a minimum charge level adapted to jumpstart the recipient.

In one embodiment, the charging cable comprises a first plug and a second plug. The first plug is adapted to connect the charging cable to a charging outlet of the donor, and the second plug is adapted to connect the charging cable to the second battery pack of the recipient.

In an embodiment, the connector further comprises a detection circuit. The method further comprises: determining that the donor is connected to the recipient via the charging cable using the detection circuit. The detection circuit comprises one or more electronic battery sensors that determines one or more first charging configuration parameters of the first battery pack of the donor and the one or more second charging configuration parameters of the second battery pack of the recipient. The one or more electronic battery sensors may be electrically coupled to the first battery pack of the donor and the second battery pack of the recipient. In an embodiment, the method further comprises: determining a first potential at a first plug and a second potential at a second plug based on the one or more first charging configuration parameters of the first battery pack of the donor and the one or more second charging configuration parameters of the second battery pack of the recipient, respectively. The method further comprises: determining that the donor is connected to the recipient based on comparing the first potential at the first plug and the second potential at the second plug.

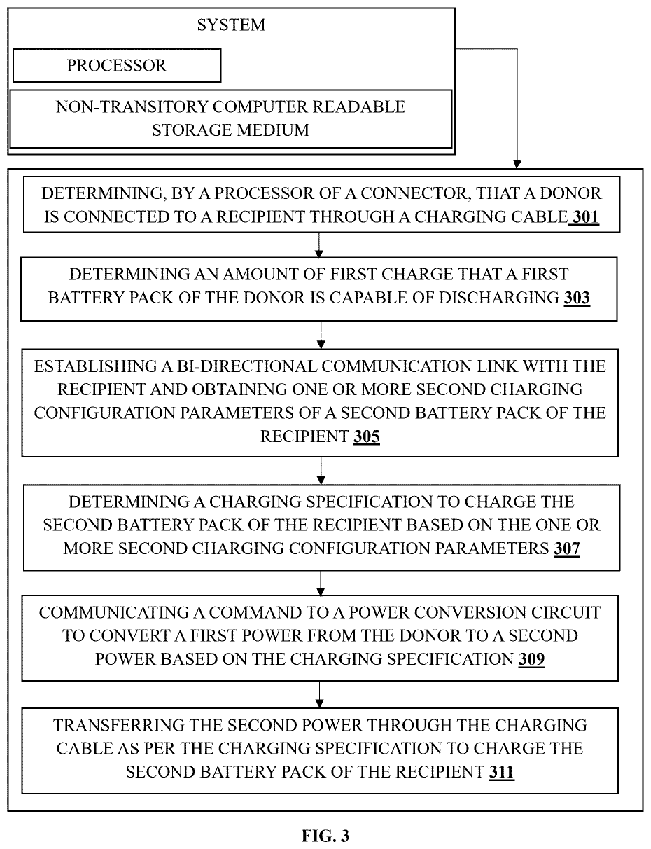

In an aspect, a non-transitory computer readable storage medium is described. As an example, FIG. 3 illustrates a non-transitory computer readable storage medium, according to one or more embodiments. A non-transitory computer readable storage medium comprising a sequence of instructions which when executed by a processor causes: determining that a donor is connected to a recipient through a charging cable (at step 301); determining an amount of first charge that a first battery pack of the donor is capable of discharging (at step 303); establishing a bi-directional communication link with the recipient and determine one or more second charging configuration parameters of a second battery pack of the recipient (at step 305); determining a charging specification to charge the second battery pack of the recipient based on the one or more second charging configuration parameters (at step 307); communicating a command to a power conversion circuit to convert a first power from the donor to a second power based on the charging specification (at step 309); and transferring the second power through the charging cable as per the charging specification to charge the second battery pack of the recipient (at step 311).

In an embodiment, the donor is a first vehicle that comprises abundant charge and the recipient is a second vehicle that comprises negligible charge. The donor comprises one of an electric vehicle (EV), a hybrid electric vehicle (HEV), an internal combustion engine vehicle (ICEV), and a plug-in hybrid electric vehicle (PHEV). The recipient comprises one of an electric vehicle (EV), a hybrid electric vehicle (HEV), an internal combustion engine vehicle (ICEV), and a plug-in hybrid electric vehicle (PHEV). The one or more second charging configuration parameters comprises at least one of a rated charging capacity, a charge-discharge rate, a state-of-charge (SoC), a state-of-health (SoH), a charging duration, a nominal voltage, and a maximum charging voltage. The charging specification comprises at least one of a charging voltage, a charging current, a charging power, a charging duration, a charging temperature, a charging sequence, and an optimal charge percentage level to stop charging. The first power comprises a first voltage and the second power comprises a second voltage.

In an embodiment, the non-transitory computer readable storage medium further causes: communicating with one of a first vehicle computer system of the donor and an external database to extract itinerary information of the donor. The itinerary information of the donor comprises at least one of a departure point, a departure time, an intermediate point, a waiting duration, an arrival time, and a destination point. The non-transitory computer readable storage medium further causes: receiving a state-of-charge of the first battery pack of the donor from one of a battery management system and the first vehicle computer system of the donor; determining an anticipated routing and determining an amount of second charge required to execute and complete the anticipated routing based on the itinerary information of the donor; and determining the amount of first charge, that the first battery pack of the donor is capable of discharging, from the state-of-charge of the first battery pack and the amount of second charge required to execute and complete the anticipated routing.

In an embodiment, the charging cable comprises a first plug and a second plug. The first plug is adapted to connect the charging cable to a charging outlet of the donor, and the second plug is adapted to connect the charging cable to the second battery pack of the recipient.

In an embodiment, the non-transitory computer readable storage medium further causes: transferring the second power through the charging cable to the second battery pack of the recipient to jumpstart the recipient. In another embodiment, the non-transitory computer readable storage medium further causes: transferring the second power through the charging cable to the second battery pack of the recipient to charge the recipient. In another embodiment, the non-transitory computer readable storage medium further causes: transferring the second power through the charging cable till an indication is received by a processor. In an embodiment, the non-transitory computer readable storage medium further causes: receiving the indication from at least one of an external device and a second vehicle computer system of the recipient upon charging the second battery pack to an optimal charge percentage level. The optimal charge percentage level is a minimum charge level adapted to jumpstart the recipient.

In an embodiment, a connector further comprises a detection circuit. According to this embodiment, the non-transitory computer readable storage medium further causes: determining that the donor is connected to the recipient via the charging cable using the detection circuit. The detection circuit comprises one or more electronic battery sensors that determines one or more first charging configuration parameters of the first battery pack of the donor and the one or more second charging configuration parameters of the second battery pack of the recipient According to this embodiment, the one or more electronic battery sensors may be electrically coupled to the first battery pack of the donor and the second battery pack of the recipient.

In an embodiment, the non-transitory computer readable storage medium further causes: determining a first potential at a first plug and a second potential at a second plug based on the one or more first charging configuration parameters of the first battery pack of the donor and the one or more second charging configuration parameters of the second battery pack of the recipient, respectively. According to this embodiment, the non-transitory computer readable storage medium further causes: determining that the donor is connected to the recipient based on comparing the first potential at the first plug and the second potential at the second plug.

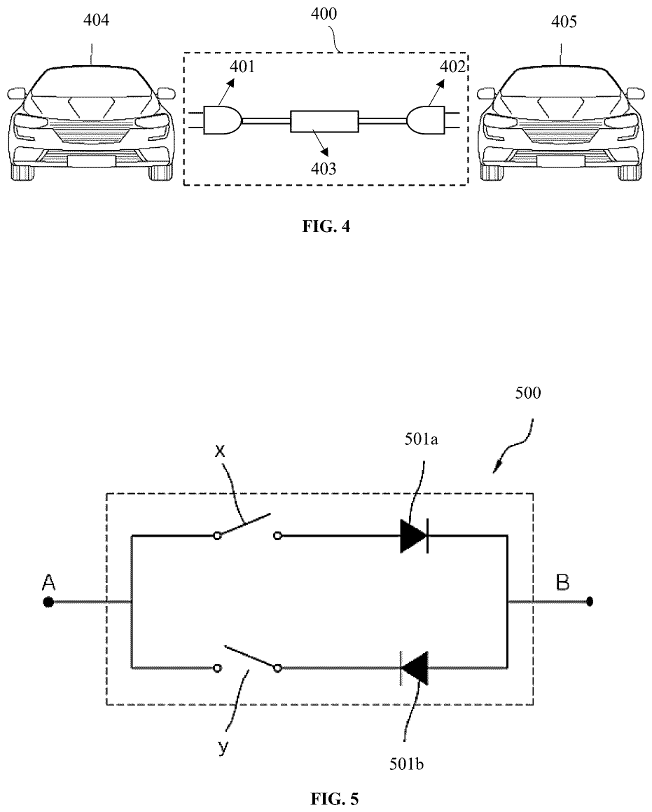

As an example, FIG. 4 illustrates a schematic diagram illustrating a technical idea of a vehicle-to-vehicle charge transfer at a high level, according to one or more embodiments. The connector comprises a charging cable 400 for charging a vehicle (Vehicle-to-Vehicle). The connector is portable in size. In a preferred embodiment, the charging cable 400 comprises a first plug 401 and a second plug 402 and a main body 403.

The first plug 401 is connected to a charging terminal of the donor vehicle 404 that supplies power. The second plug 402 is connected to a charging terminal of the recipient vehicle 405 (meaning an emergency electric vehicle in which the battery is discharged) to be supplied with power.

The main body 403 is formed between the first plug 401 and the second plug 402 to control the vehicle charging. A cable is connected between the first plug 401 and the main body 403. The cable includes a power line and a communication line. Communication lines can send and receive signals in CAN communication.

As an example, FIG. 5 illustrates a reverse current protection circuit, according to one or more embodiments. The device comprises a reverse current protection circuit 500. The reverse current protection circuit 500 is adapted to prevent the flow of the current in the reverse direction. The reverse current protection circuit 500 comprises a switching circuit capable of selecting a reverse current prevention diode according to the direction of the current. When the current direction is A to B, the first switching element x is connected, and the second switching element y is opened to operate the first backflow prevention diode 501a. On the contrary, when the direction of the current is B to A, the second switching element y is operated by opening the first switching element x and connecting the second switching element y to each other by operating the second backflow prevention diode 501b. The connector determines the direction of the current by combining the charge permission signal, the charge request signal, and the state-of-charge of the battery, and then controls the first switching element x and the second switching element y.

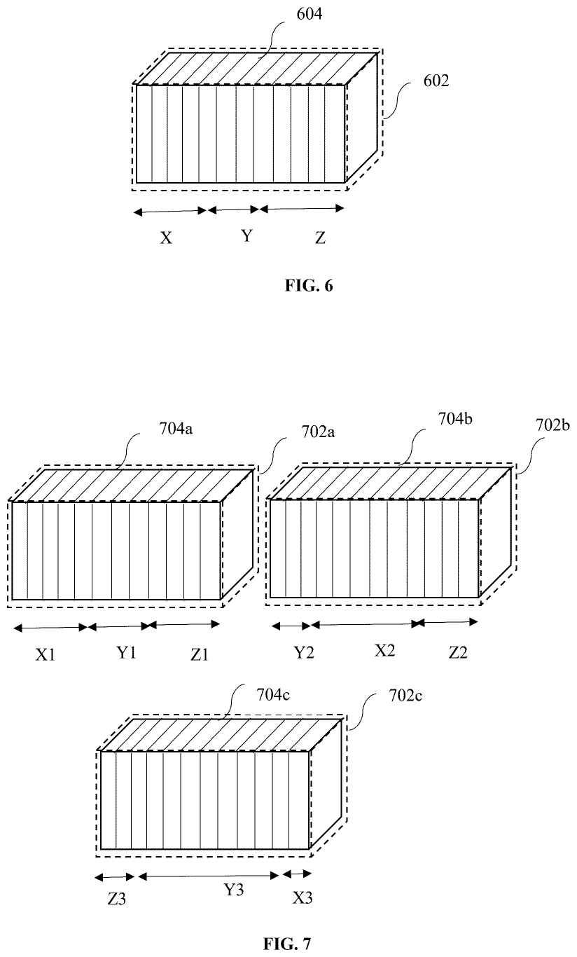

As an example, FIG. 6 illustrates a battery pack 602 comprising an individual battery, according to one or more embodiments. The battery pack 602 herein comprises an individual battery. The battery comprises a plurality of cells 604. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health information. The second portion Y may comprise a second state-of-health information. The third portion Z may comprise a third state-of-health information. In an embodiment, the first portion may refer to a portion of the battery having degraded cells. The second portion may refer to a portion of the battery having healthy cells. The third portion may refer to a portion of the battery having moderate degraded cells.

As an example, FIG. 7 illustrates a battery pack comprising a plurality of batteries, according to one or more embodiments. The battery pack herein comprises a first battery 702a, a second battery 702b, and a third battery 702c. The first battery 702a, the second battery 702b, and the third battery 702c may be identical batteries. The first battery 702a, the second battery 702b, and the third battery 702c may be non-identical batteries. In an embodiment, each battery of the battery pack may comprise equal capacity to store and deliver power. In another embodiment, each battery of the battery pack may comprise a different capacity to store and deliver power.

The first battery 702a may comprise a plurality of first cells 704a. The second battery 702b may comprise a plurality of second cells 704b. The third battery 702c may comprise a plurality of third cells 704c. Each battery of the battery pack is connected electrically to get charged by the donor vehicle. The donor vehicle may charge the batteries of the battery pack in a serial configuration, a parallel configuration, or individually.

The connector via the charging cable may charge at least one of a first portion X, a second portion Y, and a third portion Z of the battery pack. The first portion X of the battery pack refers to degraded cells from each battery of the battery pack (X=X1+X2+X3). The second portion Y of the battery pack refers to healthy cells from each battery of the battery pack (Y=Y1+Y2+Y3). The third portion Z of the battery pack refers to moderate degraded cells from each battery of the battery pack (Z=Z1+Z2+Z3). Healthy cells may be contiguously or non-contiguously located within the same battery. Similarly, degraded, and moderate degraded cells may be contiguously or non-contiguously located within the same battery.

The connector is configured to map the battery pack based on the state-of-health information. In an embodiment, the connector maps at least one of the degraded cells, the healthy cells, and the moderate degraded cells of the battery pack. The connector, upon mapping the battery pack, determines the charging sequence based on the state-of-health information and the charging duration. The connector may assign the charging sequence to particular portions of the battery pack. In an embodiment, the connector assigns the charging sequence to only the healthy cells and the moderate degraded cells of the battery pack. The connector may ignore charging the degraded cells.

As an example, FIG. 8 schematically shows a battery pack 802 and a battery management system 806, according to one or more embodiments. The battery pack 802 comprises a plurality of cells 804. The battery management system 806 may include a microprocessor, microcontroller unit, programmable digital signal processor, or another programmable device. The battery management system 806 may also, or alternatively, comprise an application specific integrated circuit, a programmable gate array or programmable array logic, a programmable logic device or a digital signal processor. Where the battery management system 806 comprises a programmable device such as the microprocessor, microcontroller unit or programmable digital signal processor mentioned above, the processor may also comprise computer executable code which controls the operation of the programmable device. In an embodiment, the battery management system 806 resides within an electric vehicle. The battery management system 806 determines the one or more charging configuration parameters (e.g., state-of-health (SoH), state-of-charge (SoC), charging duration, charging temperature, rated charging capacity, etc.) of the battery pack and communicates to the connector via the charging cable. In an embodiment, the battery management system 806 determines the state-of-health (SoH) as described below.

The battery management system 806 is configured to: measure a first battery property and a battery temperature of a battery in the electric vehicle; calculating the state-of-health (SoH) of the battery or the determined battery attributes using a predetermined model_{calc}; providing a function f for estimating the cell degradation rate; updating the state-of-health estimated in the previous time step according to:

$$S o {H}_{est} ← S o {H}_{est} + f \cdot dt + K \cdot ( S o {H}_{calc} - S o {H}_{est} )$$

where K is a gain factor that depends on the operating conditions of the vehicle, and where a reinforcement learning agent modifies K for each time step.

In another embodiment, the battery management system 806 estimates State-of-health (SoH) characteristics of a battery pack in the recipient vehicle. The estimation of the SoH includes: charging and discharging the battery pack at least one time within an upper region of a State-of-charge (SoC) window. In this case, the battery pack is charged to a first predetermined level in the upper region of the SoC window during a first time period. A first charge current impulse, then charge the battery pack for pushing the SoC level of the battery pack to a level above the first predetermined level and outside the SoC window, during a second time period. An electrical machine then discharges the battery pack to a second predetermined level within the SoC window.

The estimation of the SoH further includes: charging and discharging the battery pack at least one time within a lower region of the SoC window. In this case, the battery pack is charged to a third predetermined level outside the SoC window, during a third time period. The battery pack is then discharged by an electrical machine to a fourth predetermined level in the SoC window. A second current impulse, then discharges the battery pack, for pushing the SoC level of the battery pack to a level below the fourth predetermined level and below the SoC window, during a fourth time period.

The estimation of SoH further includes: calibrating a vehicle's battery pack by the battery management system 806 comprised in the hybrid vehicle by using the reached levels outside the SoC window for determining correct upper and lower edges of the current SoC window; and estimating the SoH characteristics of the battery pack during the charge and discharge periods by using the battery management system 806 for determining the condition of the battery pack in comparison to a new and unused battery pack by comparing the current SoC window with a standard SoC window. In an embodiment, the first and third time period is longer than the second and fourth time period, respectively. In another embodiment, the first predetermined level represents a higher voltage than the second predetermined level, and the third predetermined level represents a higher voltage than the fourth predetermined level. The connector then transfers the second power to the recipient based on the SoH. In another embodiment, the battery management system 806 is configured to determine the other charging configuration parameters and communicate to the connector via the communication link established through the charging cable. The connector then converts the first power to the second power and transfers the second power in response to the charging configuration parameters.

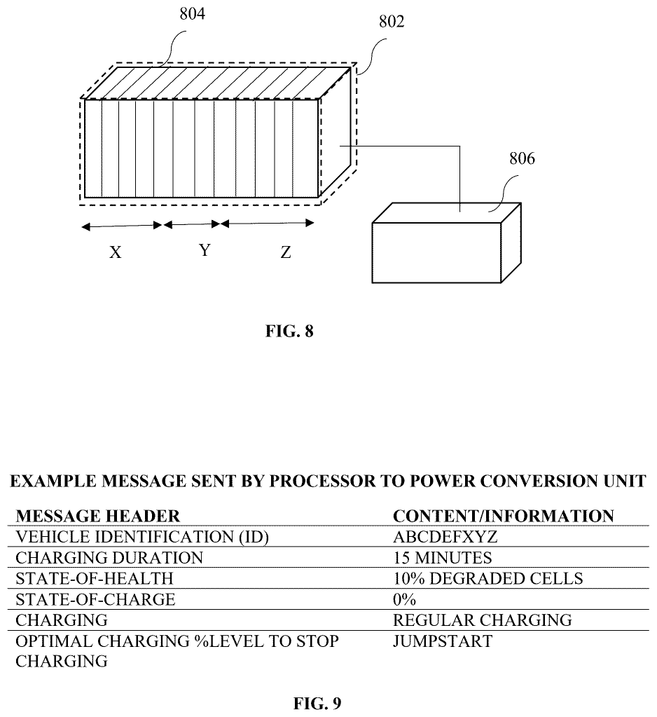

As an example, FIG. 9 illustrates a command sent by a processor to a power conversion unit, according to one or more embodiments. The message may comprise 0 to 8 bits. The sample command shown in FIG. 9 comprises fields such as vehicle ID, charging duration, state-of-health, state-of-charge, charging, and optimal charging percentage level to stop charging.

The vehicle ID may be a serial identification number, or a tag associated with the electric vehicle configured to identify and locate the electric vehicle. The charging duration may be the allotted time provided for transferring the power from the donor to the recipient. The state-of-health refers to state-of-health information of different portions of the battery pack. Charging in the charging scheme can be regular charging or trickle charging or fast charging. According to this embodiment, the charging is done as regular charging to jumpstart the recipient. The optimal charging level to stop charging refers to the objective of charging the recipient. According to this embodiment, the recipient has drained the battery and needs it to be charged to jumpstart the vehicle. The power conversion circuit, upon receiving a command as in FIG. 9, decodes and extracts the information for charging the recipient. The power conversion unit then may supply the second power according to the information received via the command to jumpstart the recipient.

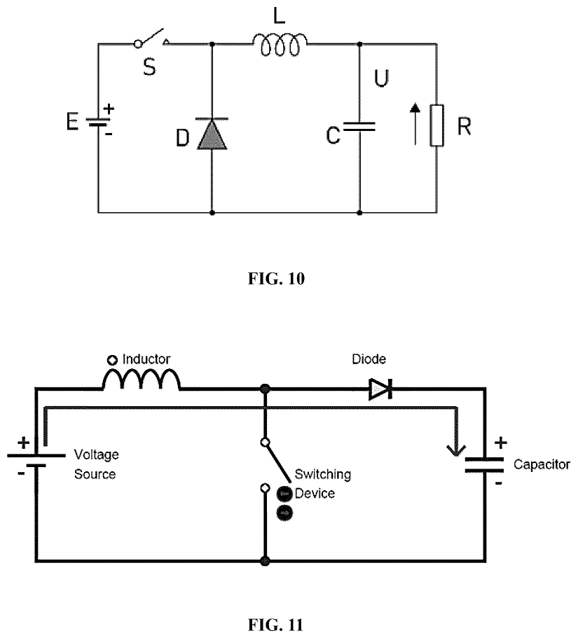

As an example, FIG. 10 illustrates a DC-to-DC converter, according to one or more embodiments. The DC-to-DC converter disclosed herein is a buck converter. FIG. 1 shows the circuit diagram of the buck converter, which consists of a source of DC power supply E, a switch S (typically a MOSFET or IGBT), a diode D, low frequency bandpass LC filter and load R. The transistor is represented by a switch S.

When the switch S is turned on, or closed, the diode D becomes inversely polarized by the supply voltage E, and the voltage across the inductor becomes equal to the difference between the supply voltage and the load voltage.

$$UL = E - U$$

The current flowing through the inductor will increase linearly from the minimum to the maximum value.

When the switch S is turned off, or opened, the commutation process occurs in which the inductor's current from the source E passes into the diode D. For better understanding the commutation process, it is necessary to consider that the inductor's winding consists of a series of coils located next to each other, so that there is not only magnetic coupling between them but also capacitive coupling, which is represented by the capacitor Cp. The moment before switching off (the switch S is opened), the voltage across the inductor is

$$uL = uCp = E - U$$

After the switch S is turned off (opened), the current through the inductor remains the same in direction and intensity and closes through the capacitor CP. In the next period, the capacitor discharges, and charges to the other side. The reverse voltage of the diode is

$$uDr = U + uL = U + uCpuDr = U + uL = U + uCp$$

and becomes zero when the voltage across the capacitor CP becomes equal to the load voltage in the opposite direction. At that moment, the diode takes over the inductor's current, so the voltage across the inductor is equal to the load voltage and the current through the inductor linearly decreases and reaches a minimum value at the end of the period.

$$uL = - U$$

Buck converters employ a simple yet effective circuit topology to step down the input voltage to a lower output voltage. The key components of a buck converter are as follows:

The high-side switch is a controlled semiconductor device that connects and disconnects the input voltage source to the rest of the circuit. It is usually a MOSFET or IGBT that is controlled by a pulse-width modulation (PWM) signal to determine the duty cycle and output voltage.

The low-side switch is another electronic device that ensures the current flows through the inductor in the appropriate direction. In non-synchronous buck converters, it is usually a diode, and in synchronous buck converters, it is typically a MOSFET. It is also controlled by a PWM signal, but with a phase difference to complement the operation of the high-side switch.

The inductor serves as an energy storage element that helps smooth the current waveform and maintain continuous current flow in the circuit. The inductor value is carefully chosen to ensure the desired conduction mode (continuous or discontinuous) and minimize output voltage ripple.

The output capacitor filters the voltage waveform to reduce voltage ripple and provides a stable output voltage for the load. The capacitance value and its equivalent series resistance (ESR), and the equivalent series inductance (ESL) all play a significant role in determining the converter's performance and the quality of the output voltage.

The control circuitry generates the PWM signals to drive the high- and low-side switches, monitors the output voltage and adjusts the duty cycle to regulate voltage. The control circuitry may use various feedback mechanisms, such as voltage-mode control, current-mode control, or advanced control strategies to optimize the converter's performance and stability.

These components, together with some additional passive components (such as input capacitors and resistors for feedback networks), form the basic circuit topology of a buck converter. By properly selecting and designing these components, a buck converter can efficiently and effectively step down the input voltage to the desired output voltage for various applications.

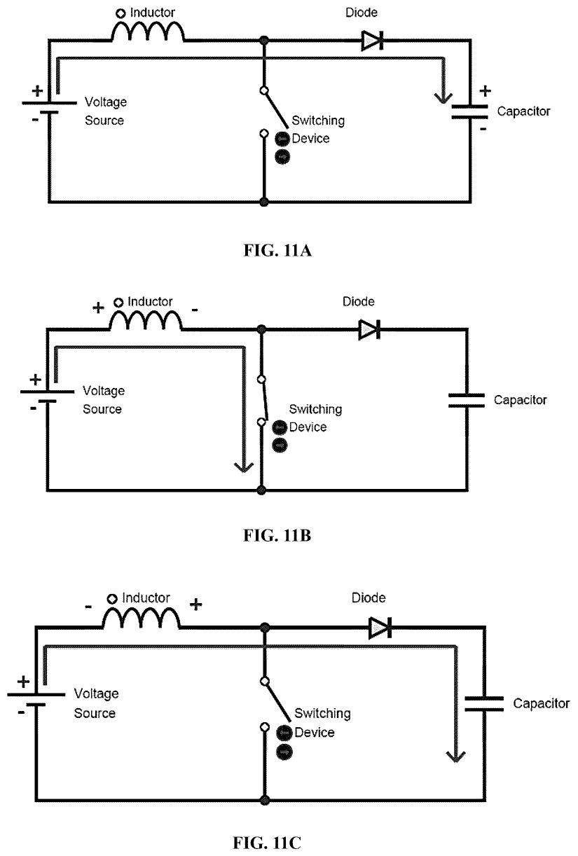

As an example, FIGS. 11, 11A, 11B and 11C illustrate a DC-to-DC converter, according to one or more embodiments. The DC-to-DC converter disclosed herein is a boost converter. FIG. 11 shows the circuit diagram of the boost converter. The boost converter is one of the simplest types of switch mode converter. The boost converter takes an input voltage and boosts or increases it and provides it as the output voltage. The boost converter comprises an inductor, a semiconductor switch (e.g., MOSFET), a diode, and a capacitor. The boost converter also needs a source of a periodic square wave which can be done using something as simple as a 555 timer or even a dedicated SMPS IC like the famous MC34063A IC.

FIG. 11A shows that the switch is off, and the output capacitor is charged to the input voltage minus one diode drop. FIG. 11B shows that the switch is on. The signal source goes high, turning on the MOSFET. The current is diverted through to the MOSFET through the inductor. Note that the output capacitor stays charged since it cannot discharge through the now back-biased diode.

The power source is not immediately short circuited since the inductor makes the current ramp up relatively slowly. Also, a magnetic field builds up around the inductor. Note the polarity of the voltage applied across the inductor. FIG. 11C shows that the switch is off, and the current to the inductor is stopped abruptly. The very nature of an inductor is to maintain smooth current flow. The inductor does not like sudden changes in current. So, the inductor does not like the sudden turning off the current. The inductor responds to this by generating a large voltage with the opposite polarity of the voltage originally supplied to it using the energy stored in the magnetic field to maintain that current flow.

The polarity symbols of the inductor get reversed. The inductor now acts like a voltage source in series with the supply voltage. This means that the anode of the diode is now at a higher voltage than the cathode and is forward biased. The output capacitor is now charged to a higher voltage than before, which means that the boost converter has stepped up a low DC voltage to a higher one. The load may be connected parallel to the output capacitor to draw the output voltage.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising”, as “comprising” is interpreted when employed as a transitional word in a claim.

Other specific forms may embody the present invention without departing from its spirit or characteristics. The described embodiments are in all respects illustrative and not restrictive. Therefore, the appended claims, rather than the description herein, indicate the scope of the invention. All variations which come within the meaning and range of equivalency of the claims are within their scope.

1-78. (canceled)

79. A device comprising:
a charging cable;
a power conversion circuit; and
a processor storing instructions in non-transitory memory that, when executed, causes the processor to:
determine that a donor is connected to a recipient through the charging cable;
determine an amount of first charge that a first battery pack of the donor is capable of discharging;
establish a bi-directional communication link with the recipient and obtain one or more second charging configuration parameters of a second battery pack of the recipient;
determine a charging specification to charge the second battery pack of the recipient based on the one or more second charging configuration parameters;
communicate a command to the power conversion circuit to convert a first power from the donor to a second power based on the charging specification; and
transfer the second power through the charging cable as per the charging specification to charge the second battery pack of the recipient.

80. The device of claim 79, wherein the device is a connector.

81. The device of claim 79, wherein the donor is a first vehicle that comprises abundant charge and the recipient is a second vehicle that comprises negligible charge.

82. The device of claim 79, wherein the one or more second charging configuration parameters comprises at least one of a rated charging capacity, a charge-discharge rate, a state-of-charge (SoC), a state-of-health (SoH), a charging duration, a nominal voltage, and a maximum charging voltage.

83. The device of claim 79, wherein the charging specification comprises at least one of a charging voltage, a charging current, a charging power, a charging duration, a charging temperature, a charging sequence, and an optimal charge percentage level to stop charging.

84. The device of claim 79, wherein the processor is operable to communicate with one of a first vehicle computer system of the donor and an external system to extract itinerary information of the donor.

85. The device of claim 84, wherein the processor is operable to
receive a state-of-charge of the first battery pack of the donor from one of a battery management system and the first vehicle computer system of the donor;
determine an anticipated routing and determine an amount of second charge required to execute and complete the anticipated routing based on the itinerary information of the donor; and
determine the amount of first charge, that the first battery pack of the donor is capable of discharging, from the state-of-charge of the first battery pack and the amount of second charge required to execute and complete the anticipated routing.

86. The device of claim 79, wherein the device further comprises a detection circuit.

87. The device of claim 86, wherein the processor is operable to determine that the donor is connected to the recipient via the charging cable using the detection circuit.

88. The device of claim 87, wherein the detection circuit comprises one or more electronic battery sensors that determines one or more first charging configuration parameters of the first battery pack of the donor and the one or more second charging configuration parameters of the second battery pack of the recipient.

89. The device of claim 88, wherein the processor is operable to determine a first potential at a first plug and a second potential at a second plug based on the one or more first charging configuration parameters of the first battery pack of the donor and the one or more second charging configuration parameters of the second battery pack of the recipient, respectively.

90. The device of claim 89, wherein the processor is operable to determine that the donor is connected to the recipient based on comparing the first potential at the first plug and the second potential at the second plug.

91. A method comprising:
determining, by a processor of a connector, that a donor is connected to a recipient through a charging cable;
determining an amount of first charge that a first battery pack of the donor is capable of discharging;
establishing a bi-directional communication link with the recipient and obtaining one or more second charging configuration parameters of a second battery pack of the recipient;
determining a charging specification to charge the second battery pack of the recipient based on the one or more second charging configuration parameters;
communicating a command to a power conversion circuit to convert a first power from the donor to a second power based on the charging specification; and
transferring the second power through the charging cable as per the charging specification to charge the second battery pack of the recipient.

92. The method of claim 91, wherein the first power comprises a first voltage and the second power comprises a second voltage.

93. The method of claim 91, wherein the charging cable comprises a first plug and a second plug the first plug is adapted to connect the charging cable to a charging outlet of the donor, and the second plug is adapted to connect the charging cable to the second battery pack of the recipient.

94. The method of claim 91, wherein the method further comprises: transferring the second power through the charging cable to the second battery pack of the recipient to one of jumpstart and charge the recipient.

95. A non-transitory computer readable storage medium comprising a sequence of instructions which when executed by a processor causes:
determining that a donor is connected to a recipient through a charging cable;
determining an amount of first charge that a first battery pack of the donor is capable of discharging;
establishing a bi-directional communication link with the recipient and obtaining one or more second charging configuration parameters of a second battery pack of the recipient;
determining a charging specification to charge the second battery pack of the recipient based on the one or more second charging configuration parameters;
communicating a command to a power conversion circuit to convert a first power from the donor to a second power based on the charging specification; and
transferring the second power through the charging cable as per the charging specification to charge the second battery pack of the recipient.

96. The non-transitory computer readable storage medium of claim 95, further causes: transferring the second power through the charging cable till an indication is received by the processor.

97. The non-transitory computer readable storage medium of claim 96, further causes: receiving the indication from at least one of an external device and a second vehicle computer system of the recipient upon charging the second battery pack to an optimal charge percentage level.

98. The non-transitory computer readable storage medium of claim 97, wherein the optimal charge percentage level is a minimum charge level adapted to jumpstart the recipient.
